(19) United States
(12) Patent Application Publication
(10) Pub. No.: US 2009/0132170 A1
(43) Pub. Date: May 21, 2009

(54) SEISMIC DATA PROCESSING AND VISUALIZATION

(76) Inventors: Alex John Krueger, Houston, TX (US); Hugo Joseph Poelen, Utrecht (NL); Brian Arthur Barran, Houston, TX (US)

Correspondence Address: DLA PIPER LLP US, P. O. BOX 2758, RESTON, VA, 20195, US

(21) Appl. No.: 12/234,443

(22) Filed: Sep. 19, 2008

Related U.S. Application Data
(60) Provisional application No. 60/974,285, filed on Sep. 21, 2007.

(51) Int. Cl. G01V 1/30; G01V 1/34

(52) U.S. Cl. 702/16; 702/17

(57) ABSTRACT

A method of processing seismic data includes storing in a single file structure a first type of data representing an inline location, a second type of data representing a crossline location, and a third type of data representing at least one of a depth and time, said first, second and third type of data each being associated with a horizon of a poststack seismic trace at a location defined by said inline location and said crossline location; and storing in said single file structure at least a fourth type of data representing an attribute associated with said horizon of said poststack seismic trace at said location.

### CROSS-REFERENCE TO RELATED APPLICATIONS

This application claims the benefit of U.S. Provisional Application No. 60/974,285, filed on Sep. 21, 2007, the disclosure of which is incorporated herein by reference in its entirety.

### FIELD OF THE INVENTION

The present invention is directed to the analysis and/or presentation of seismic data.

### BRIEF DESCRIPTION OF THE DRAWINGS

A preferred embodiment of the invention as well as alternate embodiments are described by way of example with reference to the accompanying drawings in which like numbers correspond to like elements, and in which:

FIG. 1 is a block diagram illustrating the process of gathering seismic data according to an embodiment;

FIG. 2 is a block diagram illustrating the process of gathering seismic data using multiple acoustic sources and receivers according to an embodiment;

FIG. 3 illustrates a survey area grid according to an embodiment;

FIG. 4 illustrates a prestack gather according to an embodiment;

FIG. 5 illustrates a poststack trace and a 3D volume thereof according to an embodiment;

FIG. 6 is a flow chart illustrating the storage and display of seismic data according to an embodiment;

FIG. 7 illustrates an example of a horizon tracked and/or selected from a poststack volume according to an embodiment;

FIG. 8 illustrates amplitudes of poststack traces as an example of an attribute according to an embodiment;

FIGS. 9 through 10D illustrate the selection and display of the attributes stored in a Hyper Horizon file according to an embodiment;

FIG. 10D illustrates an example of selected attributes and storage thereof in the Hyper Horizon file according to an embodiment;

FIG. 11 is a flow chart illustrating a process of prestack interpretation using poststack horizon as seed points according to an embodiment;

FIG. 12 illustrates an example of selected seed points according to an embodiment;

FIG. 13 illustrates another example of selected seed points according to an embodiment;

FIG. 14 illustrates an example of displaying poststack horizon along prestack traces according to an embodiment;

FIGS. 15A through 15D illustrate an example of a progression of sutotracking of the prestack horizon using poststack attribute as the seed points according to an embodiment;

FIGS. 15E through 15H illustrate examples of various display of prestack gather in relation to inline or crossline of the corresponding poststack trace according to an embodiment;

FIG. 16 is a flow chart illustrating a process of mapping an attribute of prestack data onto poststack horizon according to an embodiment;

FIG. 17 illustrates the selection of time/depth values of the poststack horizon as an example of starting times for extraction of attributes across the seismic traces in the corresponding prestack gathers according to an embodiment;

FIGS. 18 through 19 illustrate examples of obtaining an attribute of prestack trace at a start time selected from poststack horizon according to an embodiment;

FIG. 20 is a flow chart illustrating a process of utilizing prestack horizon as a reference in analysis of prestack gathers according to an embodiment;

FIGS. 21 through 24 illustrate examples of utilizing prestack horizon as a reference in analysis of prestack gathers according to an embodiment; and

FIG. 25 illustrate an example of tracking prestack horizon using adjacent gathers according to an embodiment.

### DETAILED DESCRIPTION OF THE SEVERAL EMBODIMENTS

Prospecting for natural resources, e.g., hydrocarbon and/or natural gas usually requires gaining of an understanding of the subterranean lithological or fluid reservoir characteristics. For many years, for example, the oil and gas industry, has been utilizing seismic surveys to model subterranean (both on land or sea floor) geology, to, for example, identify geological features of interest (such as one that is indicative of the likelihood of hydrocarbon deposits), and to determine the desired drilling location based on such model. The seismic survey modeling of the subterranean geology is based on seismic data. Seismic data is the recording of an acoustic signal which is reflected off subsurface seismic reflectors, such as geological boundaries between two dissimilar lithologic or fluid units in the earth.

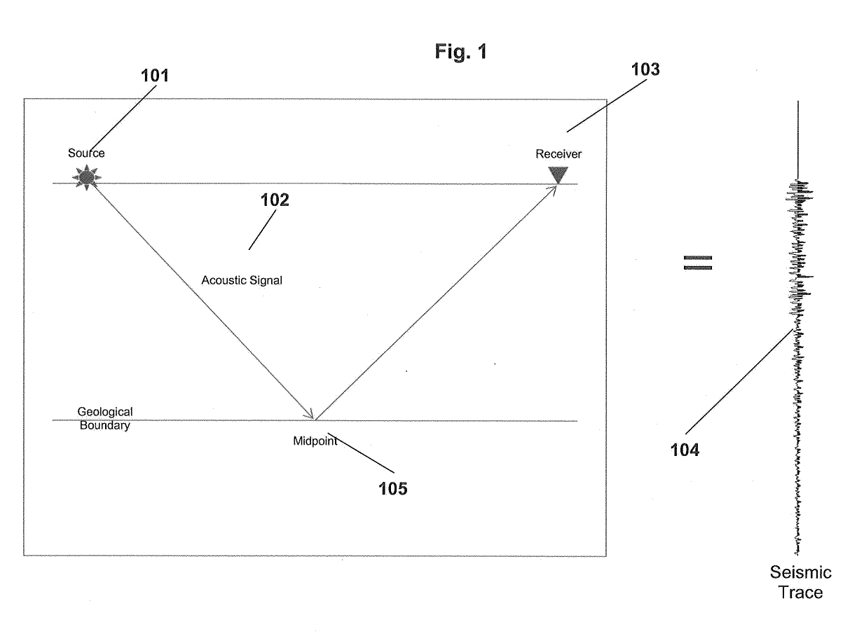

As shown in FIG. 1, in order to acquire seismic data, a source 101 (an explosion, a large hammer, an air bubble, or the like) provides the acoustic signal (or a seismic wavelet) 102. A receiver 103 (a geophone, a hydrophone, accelerometer, or the like) records the reflections. This results in a seismic trace 104. The seismic trace can be thought of as a snapshot indication of the subsurface geology at its midpoint 105, i.e., the halfway point between the source and the receiver, and may include seismic wave energy characteristics, such as the amplitude, phase, frequency, and the like, which may be indicative of various subsurface lithological or other geological properties.

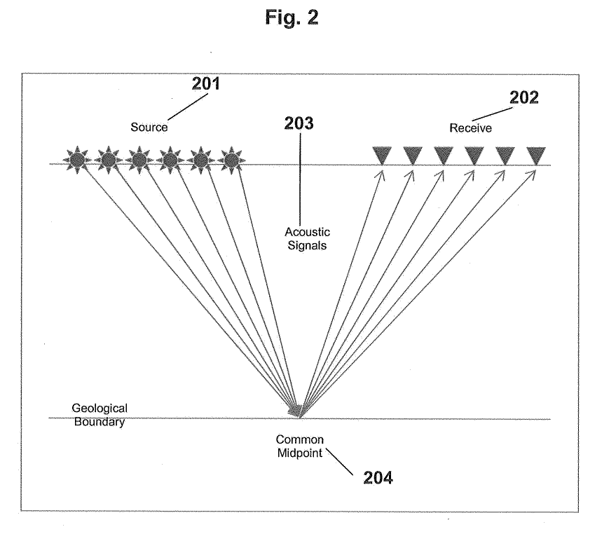

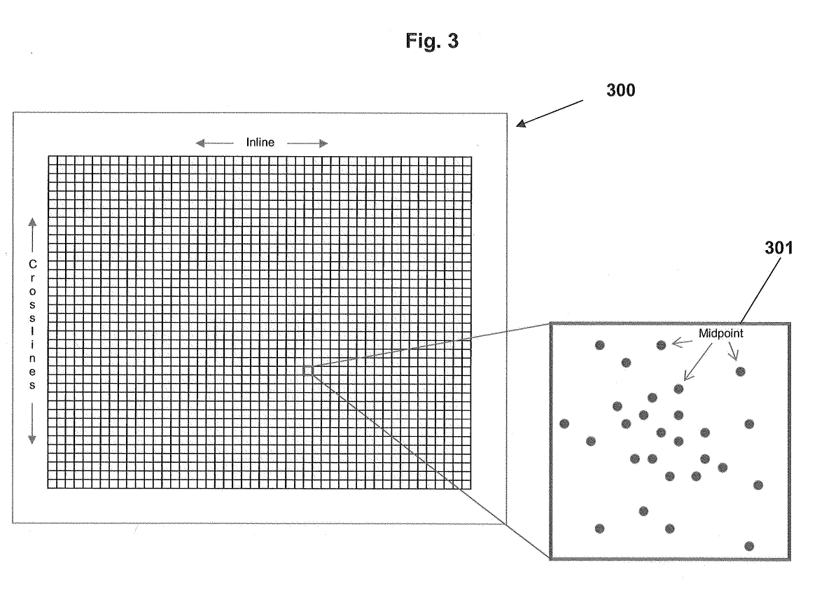

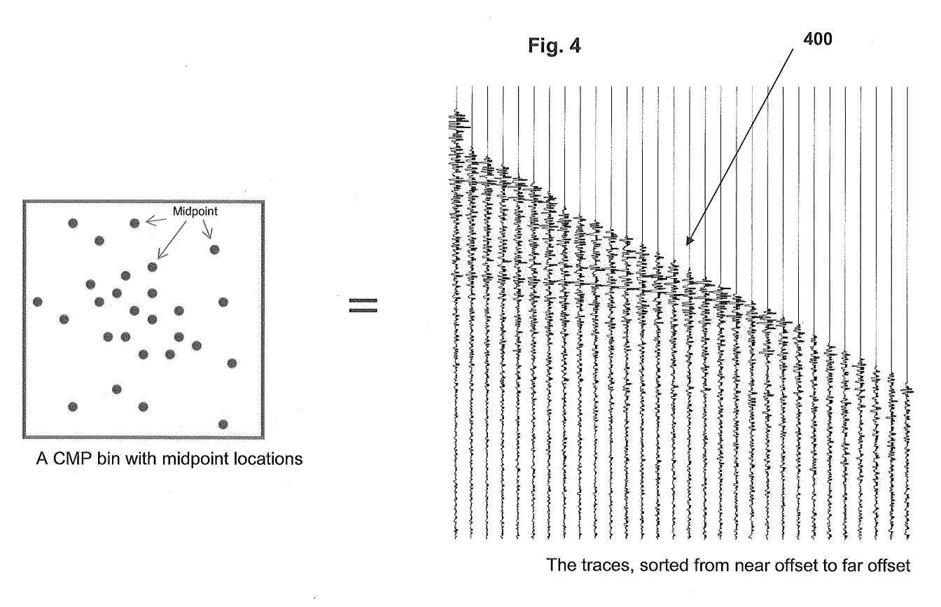

Due largely in part to the noisy nature of the seismic trace acquisition, in modern 3D seismic surveys, the concept of gathering a number of seismic traces whose midpoints lie in the same general area is typically used. As illustrated in the simplified example shown in FIG. 2, a number of sources 201 generate the acoustic signals 203, the reflection off the geological boundary at the common midpoint 204 of which are detected by the receivers 202, each of the detected acoustic wave resulting in a seismic trace. As shown in FIG. 3, during such 3D seismic survey, the area to be surveyed (or a portion thereof) is generally divided into a grid 300, whose axes are known as Inlines and Crosslines, of a number of common midpoint (CMP) bins. The collection of seismic traces whose midpoints fall in the same CMP bin 301 is known as a prestack gather.

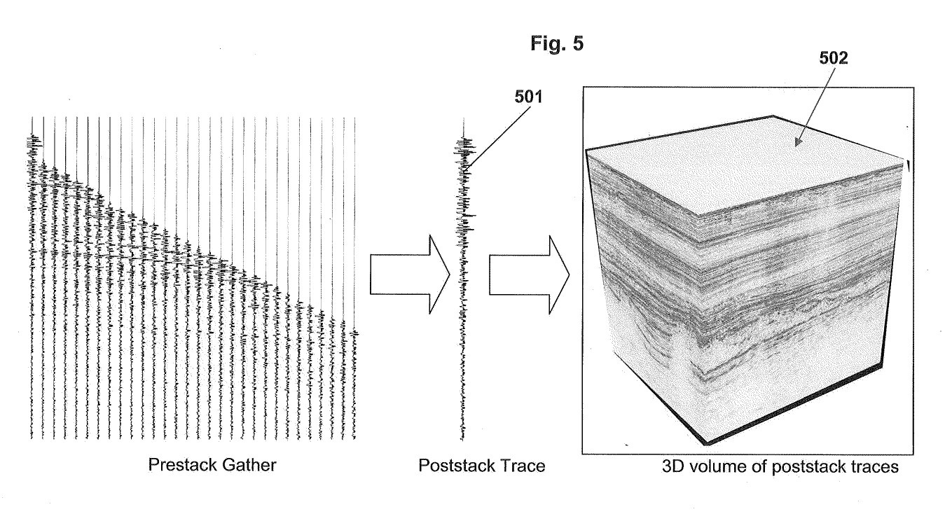

As shown in FIG. 4, the prestack gathers 400, i.e., the seismic traces with midpoints that fall in a given CMP bin 301, are commonly sorted by the offset (the distance from their source to their receiver) from near offset (i.e., the least source-receiver distance) to far offset (i.e., the greatest source-receiver distance) After applying a velocity correction to compensate for the fact that geological events on far offset traces are increasingly shifted downward in time as compared to the near offset traces (a phenomena often referred to as the normal moveout (NMO)), as well as any additional desired data processing techniques, the prestack gather can be averaged together to form a single poststack trace 501 as shown in FIG. 5. This process is known as stacking, which has the effect of canceling random noise in the prestack traces. When these poststack traces are positioned in a 3D volume at the center of their respective CMP bins, they form a 3D image 502 of the subsurface. In a sense, the prestack gathers can be thought of as extensions into additional dimensions of their corresponding poststack traces.

The 3D image is interpreted by a geophysicist or the like to find geological structure or feature of interest. The 3D seismic surveys described above requires gathering, processing and storing of enormous amount of data, typically on the order of terabytes, and requires an extensive computing resource and time. Due to the extensive time required to process the large volume of data, it is often necessary to choose between additional processing of data that may provide a more accurate visualization of the actual geological features, but which may negatively impact the project schedule, and the possible inaccuracies in the interpretation that may result in unproductive drilling, which in turn will add to the overall project cost. In addition, due in part because of the aforementioned data processing limitation, during the interpretation phase, the geophysicist has a limited number of tools at their disposal, which are typically limited to the poststack 3D volume and various time and/or depth slices view thereof.

Several novel methods, data structures and systems in which the seismic data can be stored, processed and/or visually presented, requiring less processing time are proposed herein. Also proposed are several novel analytical tools that may be used by a geophysicist during the interpretation of seismic data.

### The Hyper Horizon

A novel data structure for storing seismic data is proposed. According to the inventive data structure, the horizon file (hereinafter referred to as a “Hyper Horizon”) includes more than the three dimensional parameter of the more traditional horizon file data structure (i.e., the X/Y location coordinates and the depth/time of the horizon at the location), but comprises a multi-dimensional array of parameters to include any attribute of interest corresponding to the location in the horizon in addition to the depth/time information for each X/Y location.

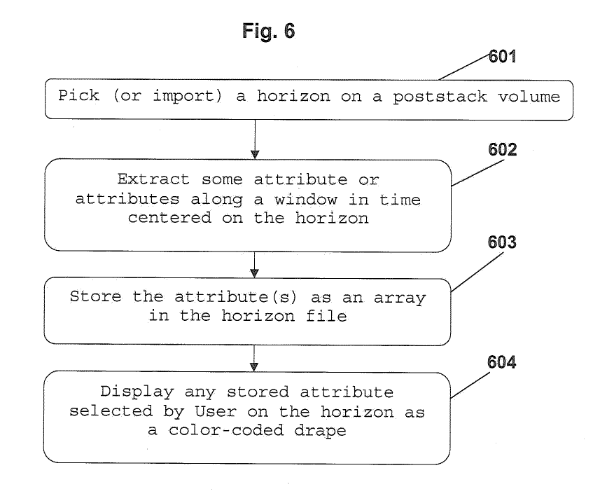

In particular, referring to FIG. 6, a horizon is chosen from the poststack seismic volume in step 601. A horizon may be either tracked on the poststack seismic data being interpreted, or imported from some other application which had performed the tracking and thus have the horizon stored as a horizon file. There are various methods for tracking horizons known in the art (e.g., amplitude-based, wavelet-based, or the like), but all are intended to define a boundary between two geologic units (e.g., layers of rock).

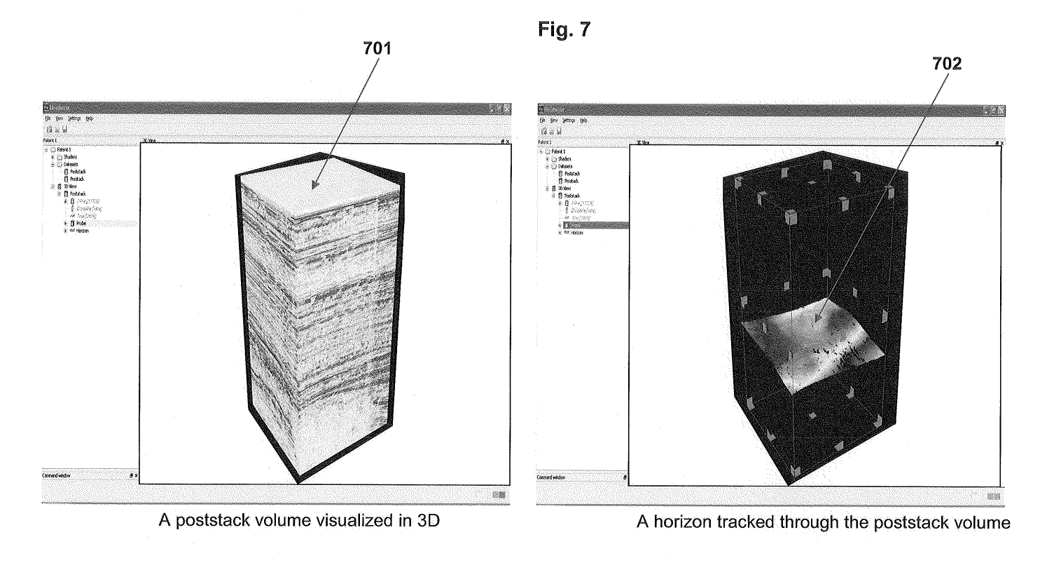

If the horizon is imported from another application, it will consist of X & Y values (geographical location values) and a Z value (time/depth of the horizon at each location). These values may or may not coincide with the X & Y locations of the seismic data to be analyzed. A 3D cube of seismic data can be thought of as a series of 2D slices in the X direction, another series of 2D slices in the Y direction, and a third series of 2D slices in the Z direction. The X and Y values are typically known as Inline and Crossline values. Each Inline and Crossline intersection will be represented by a seismic trace, which can be thought of as a continuous line from the top of the cube to the bottom, with squiggles at each geologic boundary. Each seismic trace in the poststack is created by summing together a number of prestack seismic traces. An imported horizon may not have X & Y values that correspond exactly with the X & Y values of the seismic data being analyzed, and if this is the case, an interpolation may be performed so that each seismic trace, (Inline/Crossline intersection) that is intersected by the horizon has a time/depth value for the horizon at that location. FIG. 7 illustrates a horizon 702 tracked and/or selected from a poststack volume 701.

Once a horizon is selected, in step 602, one or more attributes are extracted along the horizon. This involves analyzing the seismic data along the selected horizon, either at the point of intersection of the horizon with the seismic data, or in some user-defined window of time above and below the horizon. Examples of attributes which can be calculated include, without limitation, for example, the amplitude of the seismic data, the amplitude of the seismic data over user-defined frequency bands, the slope or dip of the horizon at each location, or the like. Other attributes may, in addition, be extracted from the corresponding prestack data from which the poststack seismic data was created.

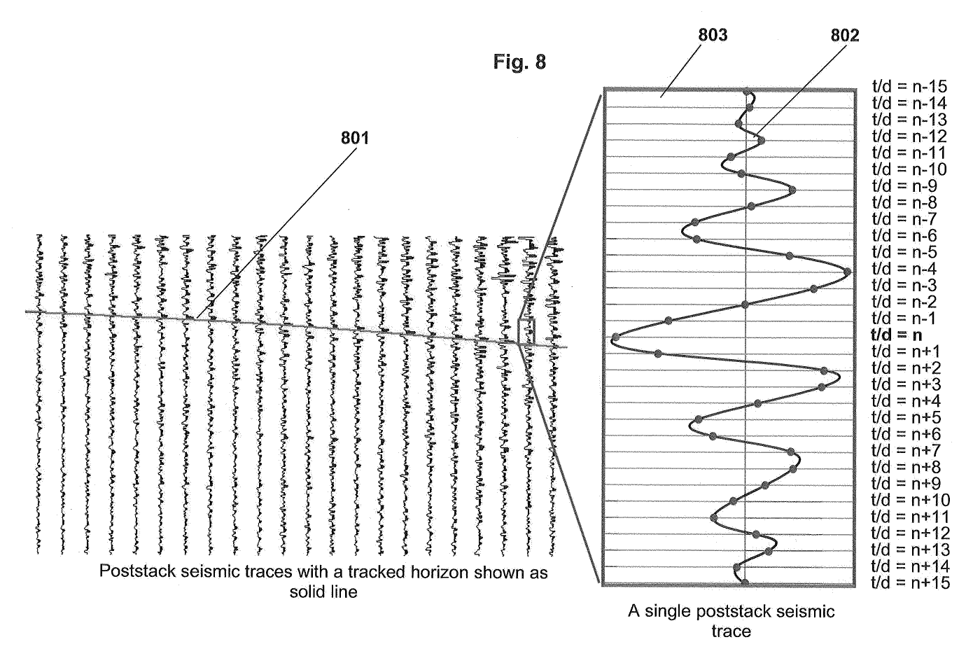

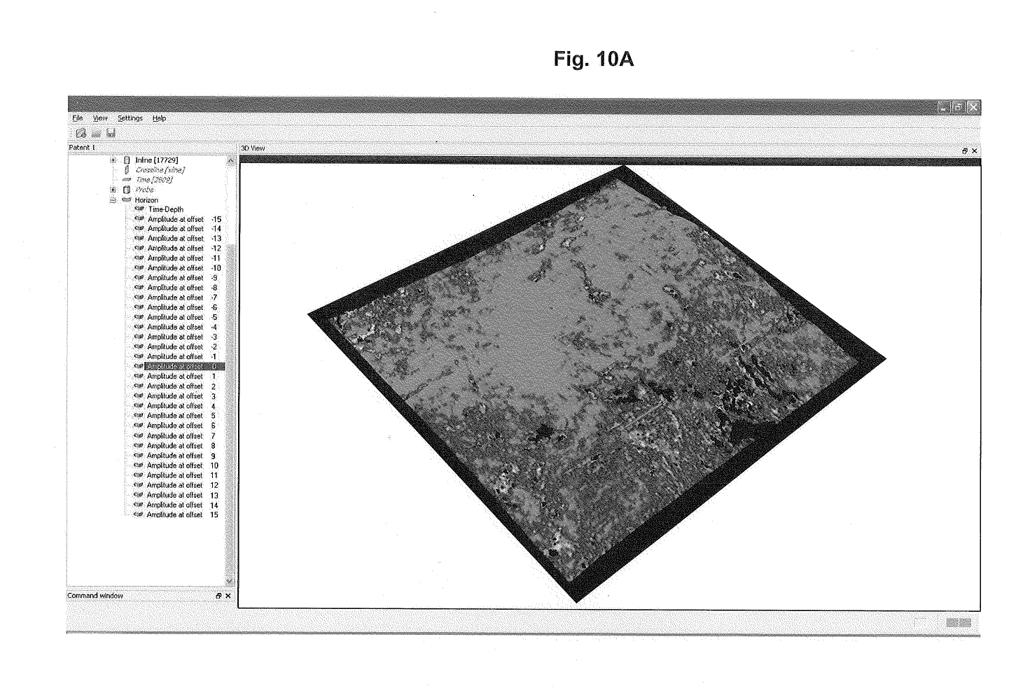

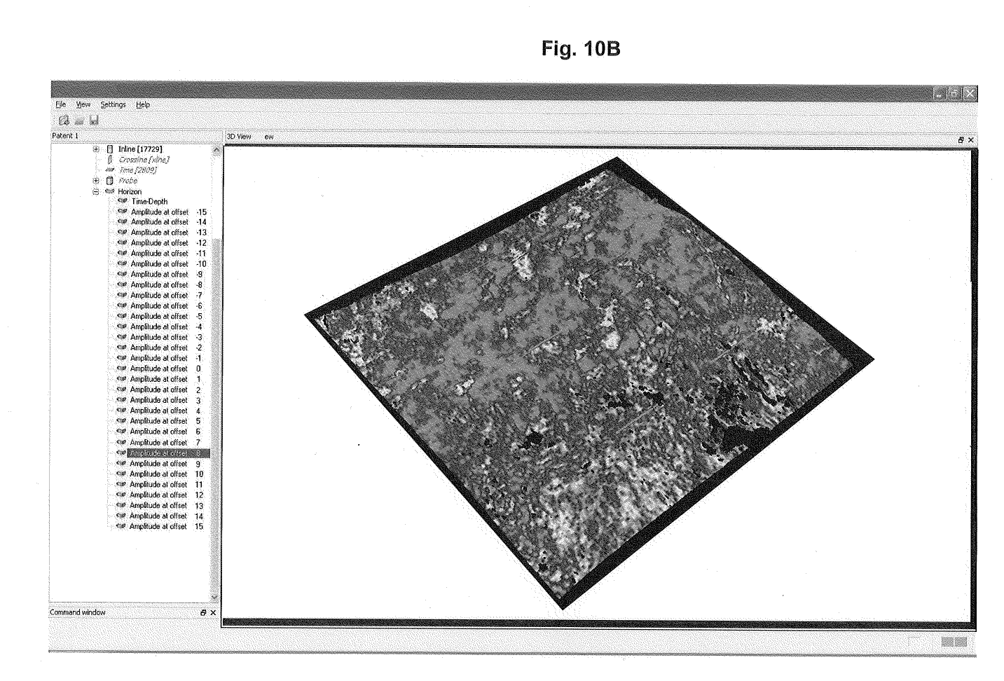

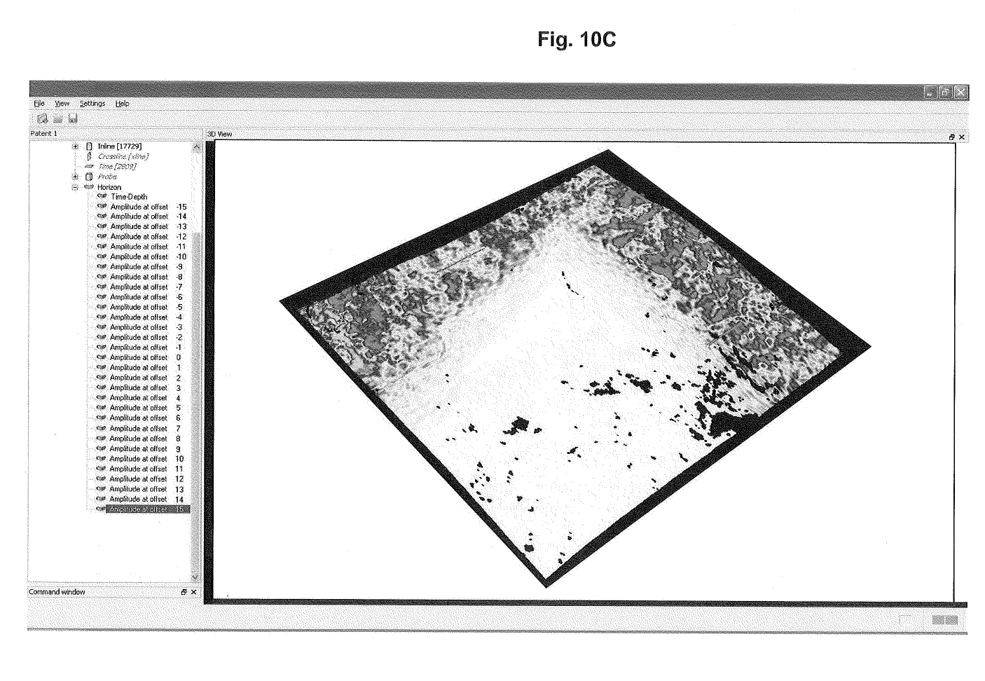

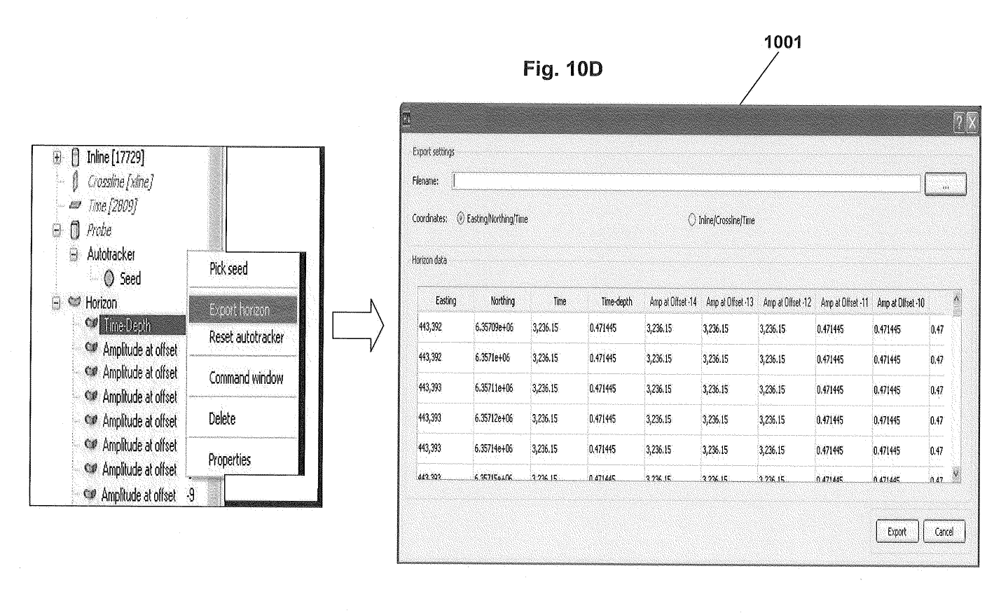

As illustrated in FIG. 8, an example of attributes may be the amplitudes of each poststack trace 802 intersected by the horizon 801 within a user defined window 803, for example, +/−15 samples above and below the horizon time at each trace. Once the desired attributes have been extracted from the seismic data, in step 603, the extracted attributes can be stored in the Hyper Horizon file 1001 as shown in FIG. 10D. As shown in FIG. 10D, the extracted attributes can be stored in the physical Hyper Horizon file 1001, and may include the typical X, Y and Z values (the X & Y values are the geographical locations, usually either latitude/longitude or, as illustrated in FIG. 10D, easting/northing values, the Z value is the time/depth of the horizon at each X/Y location) and, in addition to the time/depth value, an array of attribute values associated with each X/Y location.

Once the desired attributes have been extracted from the seismic data as above described, they are available for interactive display in step 604, as further described below.

According to an aspect of the present inventive feature, any of the extracted attributes can be selected by the user for display, and may be processed and/or rendered as visual representation by the graphics processing unit (GPU) of the graphics card of a computer, rather than the main CPU residing on the main board. The extremely high memory and computational bandwidth of the GPU and memory system found on-board a graphics card enables much faster attribute processing and rendering. While for the purpose of illustration, a GPU is referred to as the processor of a typical graphics card, it should be noted that a GPU is not required to be disposed on a graphics card of a personal computer. Indeed, it is also possible to have a GPU or even a cluster of several GPUs being utilized to implement the seismic processing herein described regardless of whether the GPU or the cluster of GPUs is physically found on a graphics card.

The GPUs available today utilizes massive parallel processing architecture with multiple pipelines, and are capable of performing floating point operations at a much higher rate than a typical central processing unit (CPU), e.g., available from Intel or AMD, found on the main board of a computer. With available graphics memory reaching comparable sizes to standard workstations it is now feasible to manage all attribute data on the GPU. This data locality, coupled with the high floating point performance of the GPU, allows interactive parameter editing and more computationally intensive algorithms. In addition, the results of any computation on the graphics processor may be directly visualized on the display from the graphics memory, obviating the need to transfer data from the host (CPU) or system memory of the main board to the graphics device. Theoretical transfer rates along from the host to the graphics device along, for example, a PCI-Express bus are limited to 8.0 gigabytes per second, while transfer rates from graphics device memory to the GPU are around 76.8 gigabytes per second, a factor of almost 10. Processing data that is available 10 times faster reduces the data access bottleneck found in most data-local algorithms.

For the purpose of illustration, an implementation of the processing and rendering of the attribute data using a GPU based on the OpenGL (Open Graphics Library) standard, originally developed by Silicon Graphics Inc., is described below. However, it should be noted that other implementations based on any other graphics API platform, e.g., the Direct3D platform developed by Microsoft, can also be made.

According to the OpenGL implementation, the selected attributes may be loaded into, e.g., a high-performance data buffer object on the GPU called a “vertex buffer object”, or VBO. This VBO is rendered as a custom vertex attribute channel along with the horizon geometry. A shader program, specifically two GPU-based sub-programs that transform geometry into pixels on the display screen, is then used to sample the horizon data per-vertex and convert the same into a visual variation, e.g., grey level or color value using a lookup texture.

More particularly, the implementation makes use of the programmable graphics pipeline of modern graphics cards provided by the OpenGL API. The two GPU based sub-programs are complied, linked and transferred to the GPU via the OpenGL API. Even more specifically, the two sub-programs are written in, e.g., the OpenGL Shading Language (GLSL), and may be executed by the GPU as a custom or modified shader programs. The first of the two sub-program, a vertex program is used to transform the position data in the Hyper Horizon file and any user selected horizon attribute data associated with the position. This “vertex shader” effectively pipes data into the rasterizer, a hardware-based process before the execution of the second of the two sub-program in the graphics pipeline. The rasterizer projects the geometry onto a 2D plane representing the user's display and generates tiny fragments that will eventually become pixels on the screen. Each fragment is used as input to the second sub-program, the “fragment shader”. Position, normal, color, and any other custom attribute is transferred to the fragments using the GPU's hardware interpolation. To derive the final fragment color and/or grey level, the custom attribute values are used to lookup a color and/or grey level value stored in a texture table. Just before rendering of the horizon surface, the two sub-programs are allowed to be executed rather than the default OpenGL geometry pipeline. The lookup texture described above is shader dependent, and is bound as a texture at this time as well. After rendering of the horizon surface, the program is unbound and the default OpenGL functionality can be resumed.

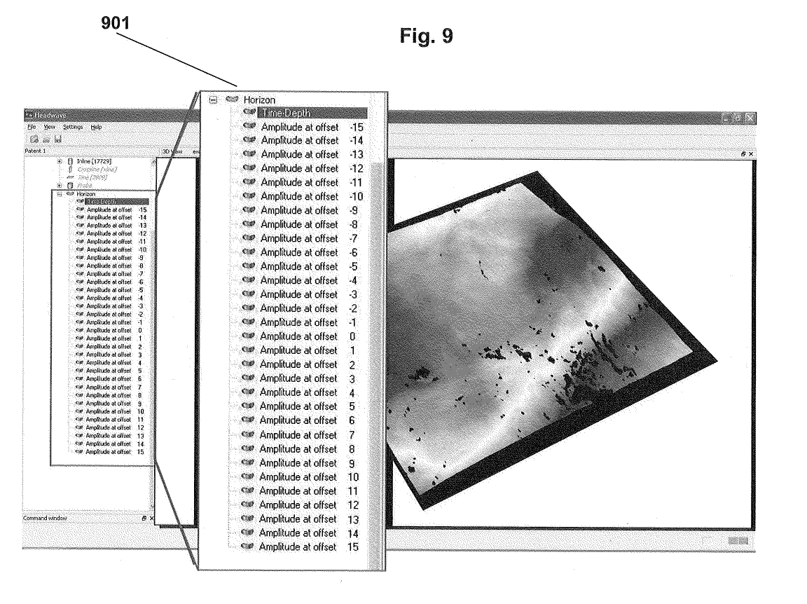

FIGS. 9 through 10C illustrate the ability of a user to interactively select any of the attributes stored in a Hyper Horizon file, and to render or drape the selected attributes onto the horizon as different colors or grey level. As shown in FIG. 9, the horizon is displayed as a 3D object, along with a list of the available attributes 901 associated with the selected horizon. Continuing with the previous example, the available attributes the user had selected and stored in the Hyper Horizon file in this example are the amplitude data within the +/−15 samples of the horizon. When user selects one of the available attributes, the selected attributes are rendered by the GPU as described above as, e.g., a color or grey level coded drape over the horizon. For example, when the user selects the zero offset from the horizon, the amplitudes of the seismic data along the horizon is displayed as shown in FIG. 10A. FIG. 10B shows the display when the user selects the offset 8 samples above the horizon. FIG. 10C shows the display when the user selects the offset 15 samples above the horizon. While in FIGS. 9-10C, the different amplitudes are shown as different levels or shades of grey corresponding to the different levels of amplitude, it should be readily apparent that the different amplitude values can be assigned corresponding respective different colors.

It should be noted that the Hyper Horizon file structure described herein allows the user to perform any mathematical operations to the selected attributes utilizing the high rate floating operation capability of the GPU. The Hyper Horizon file structure of having stored therein one or more attributes associated with horizon has multiple advantages, particularly when the attributes are processed and rendered by the GPU as described above. Among other things, the data structure allows leveraging the real-time shader functionality, or the ability to map arbitrary attribute values to color or grey level output, of modern graphics processors. These programmable shader objects can be custom tailored easily to help locate vital or important features in the data.

### The Use of Poststack Horizon as Seed Points for Prestack Interpretation

A novel analytical tool is provided in which the time/depth values for X/Y locations of a selected poststack horizon are used as the seed or starting points to track horizon of the prestack gathers.

In particular, referring to FIG. 11, in step 1101, a horizon is chosen from the poststack seismic volume as previously described in connection with FIG. 6. In step 1102, as also previously described, if the horizon is imported from another application, an interpolation may be performed to ensure that each seismic trace, (Inline/Crossline intersection) that is intersected by the horizon has a time/depth value for the horizon at that location.

As previously discussed, each poststack seismic trace was created by averaging a number of prestack seismic traces. These prestack gathers can be sorted in terms of offset, which is the distance between the seismic source, (blast, imploding bubble, etc.) and the seismic receiver (geophone, hydrophone, etc.). The near offset trace is that with the least distance between source and receiver, and the far offset trace is that with the most distance.

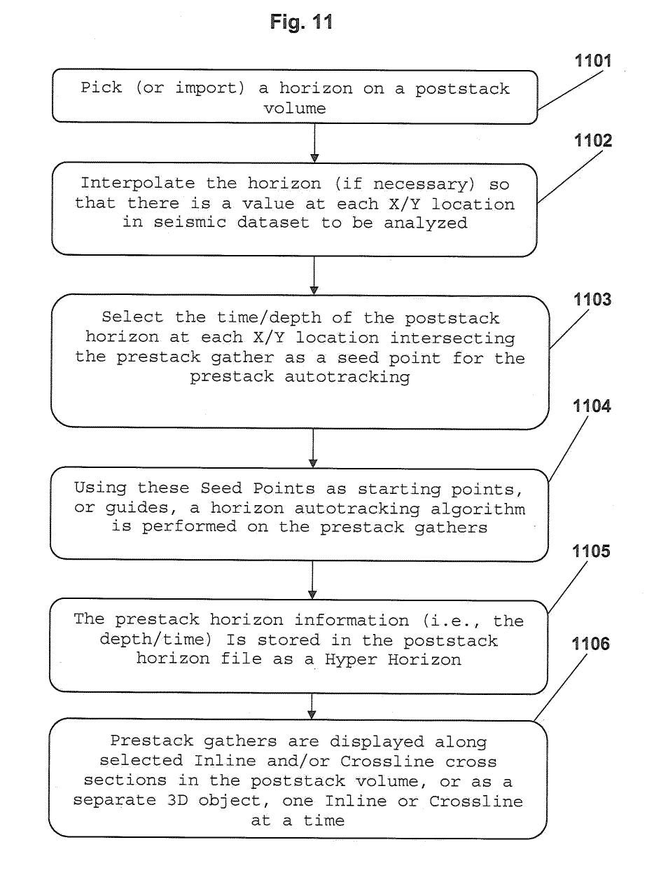

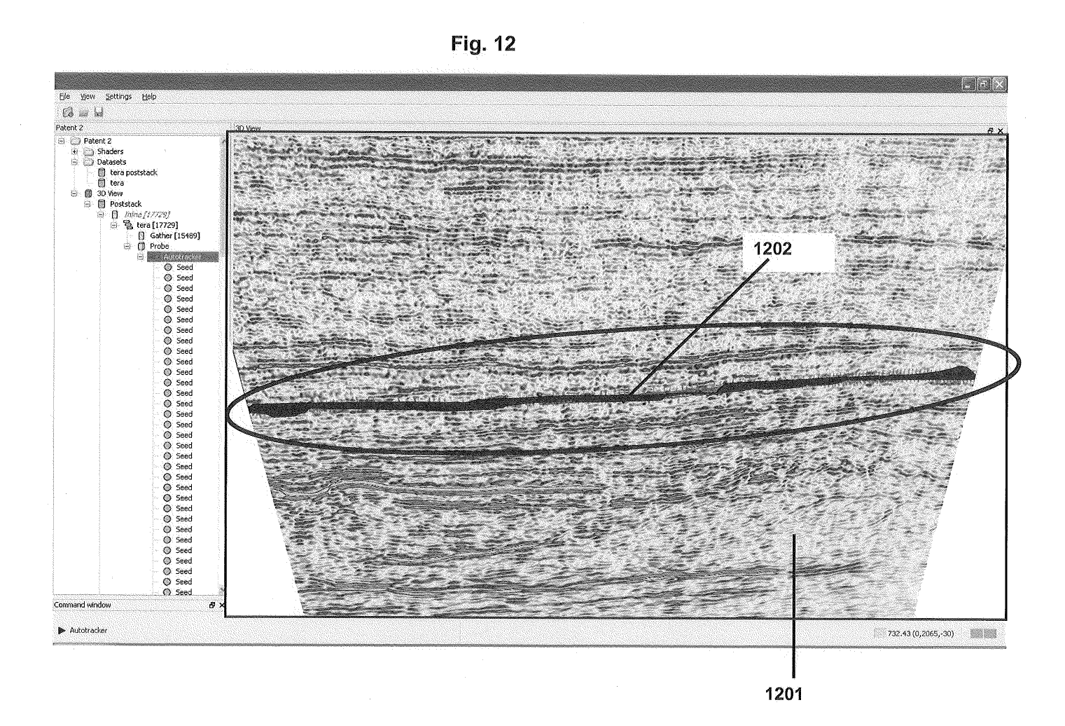

In step 1103, at each prestack gather (or any user-defined subset of gathers) which is intersected by the poststack horizon, the time/depth of the poststack horizon at the intersection is selected as the seed point, for example, on the near offset trace. A seed point can be thought of as a starting point for a horizon autotracking algorithm. It can identify, for example, a target amplitude or wavelet shape. The autotracking then searches its neighboring seismic traces for similar values. When similar values are found, they become part of the newly autotracked horizon. FIG. 12 illustrates the selected seed points 1202 (indicated by the circle) on the near offset prestack traces 1201.

A horizon autotracking algorithm is performed on the prestack dataset in step 1104, using the poststack horizon to define the target amplitude, wavelet or other tracking characteristic. In this illustration, these starting points, or seed points, are placed on the near offset traces of each of the prestack gathers on which the autotracking is to be performed, as the seismic signal tends to be stronger on the near offset traces, and weaker on the far offset traces. However, the prestack horizon tracking can be performed on any prestack trace at any offset.

The tracked prestack horizon is then stored in the Hyper Horizon as attributes in step 1105 as previously described. Since the process of tracking a horizon on seismic data (for both poststack and prestack data) generally consists of defining one or more seed points, performing an autotracking algorithm, the user may be allowed during the horizon tracking process to edit, or make refinements to the resulting horizon. This may consist of adding, deleting or editing the location of the seed points, choosing different parameters for the autotracking algorithm, altering or deleting portions of the resulting horizon, or the like.

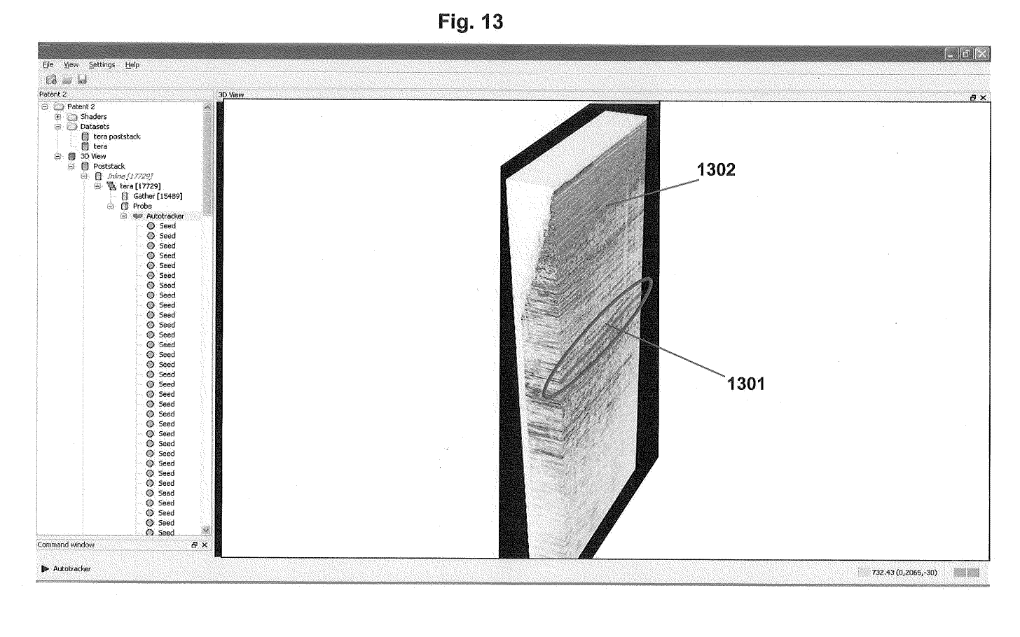

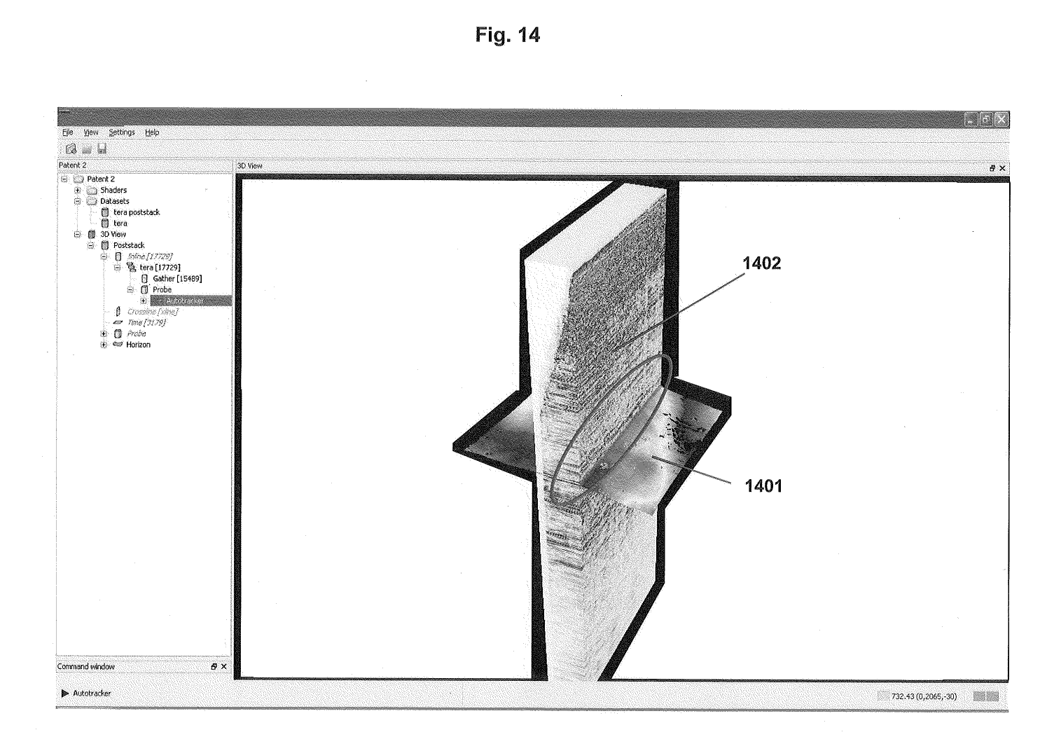

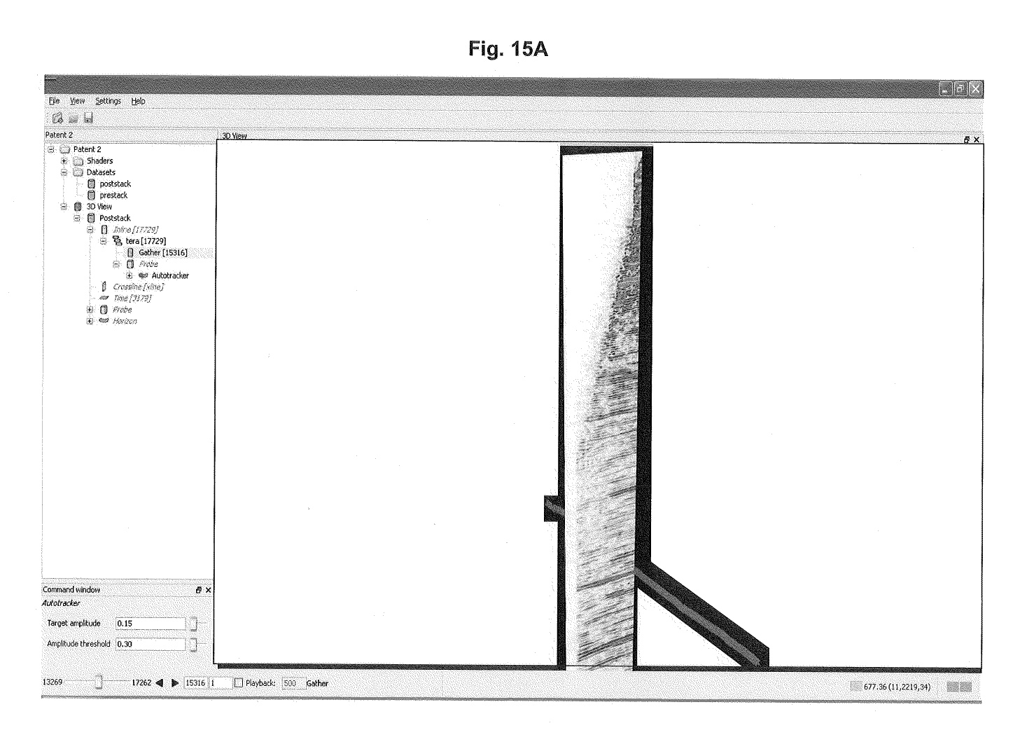

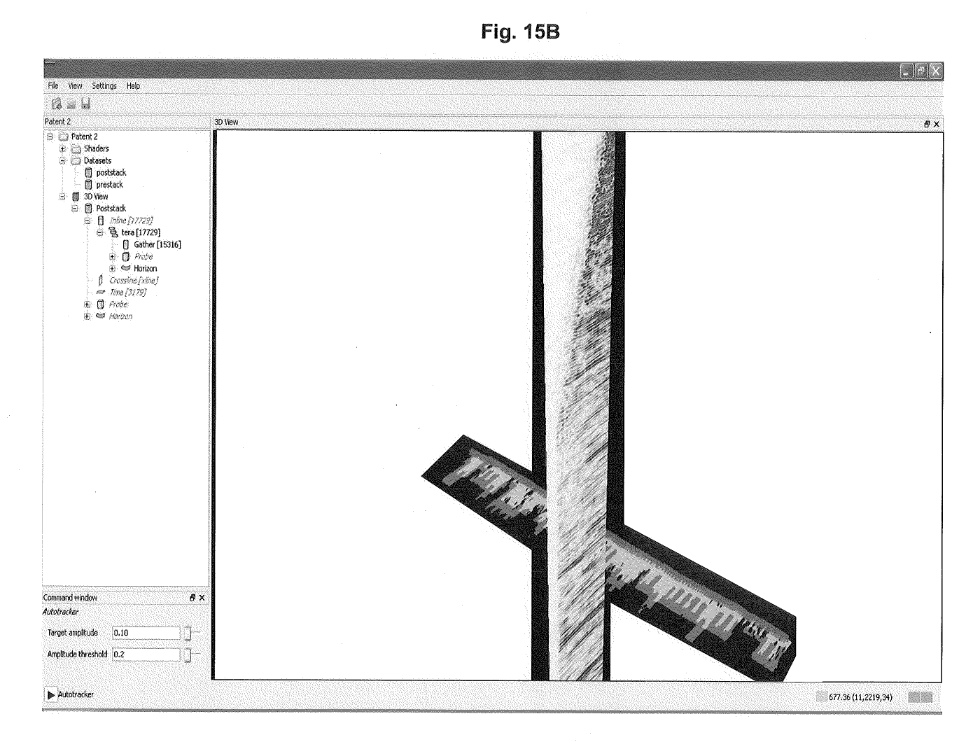

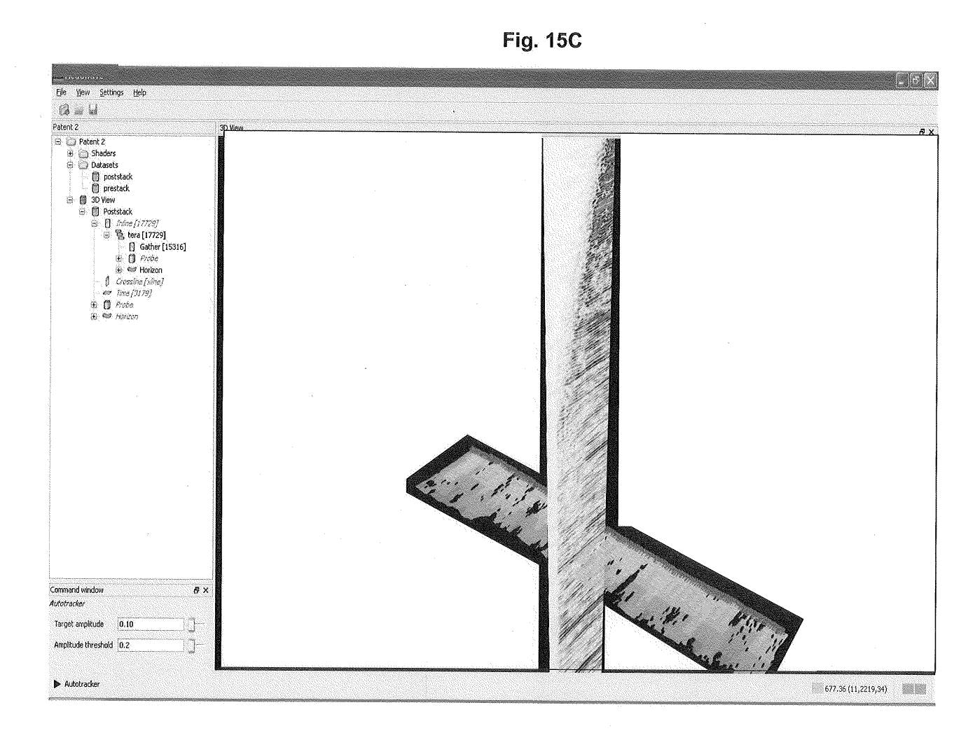

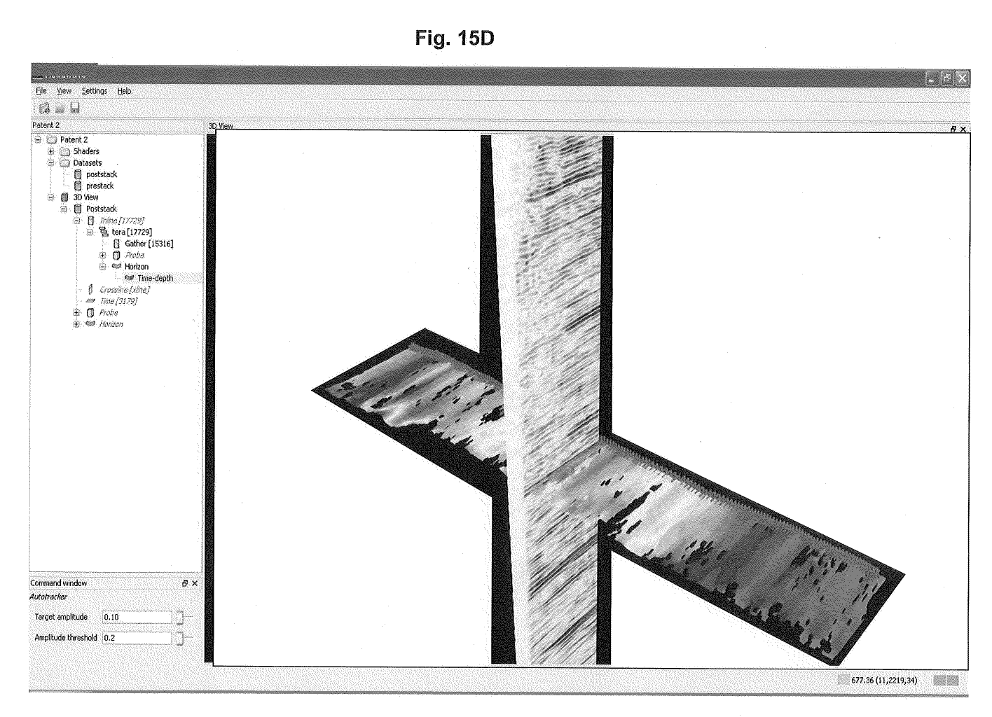

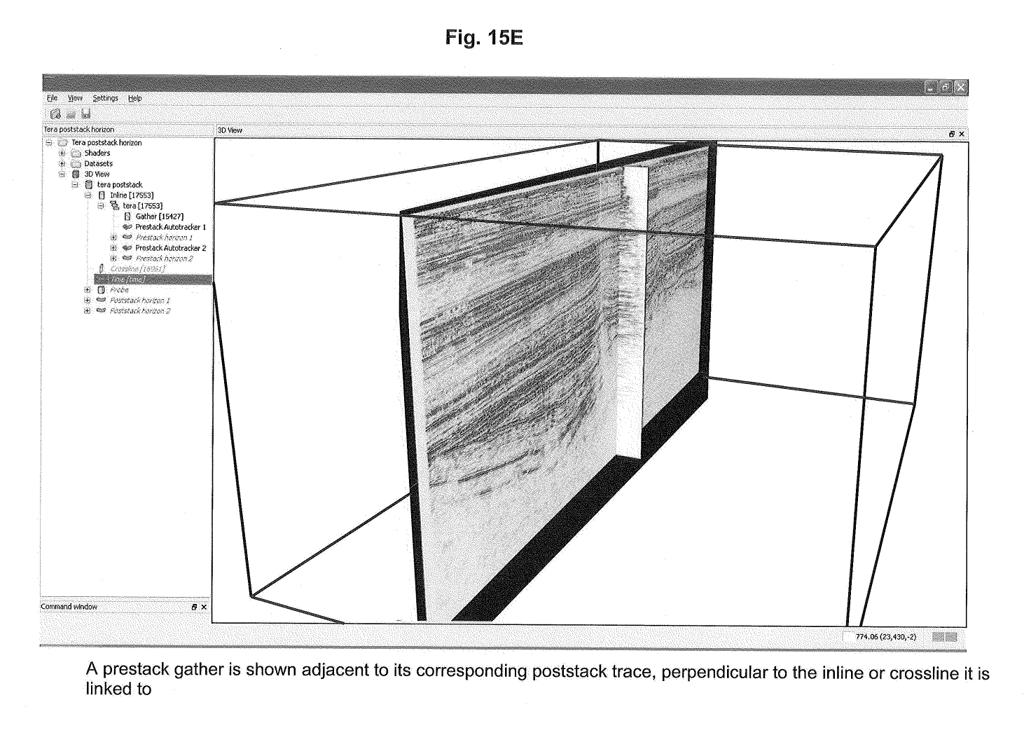

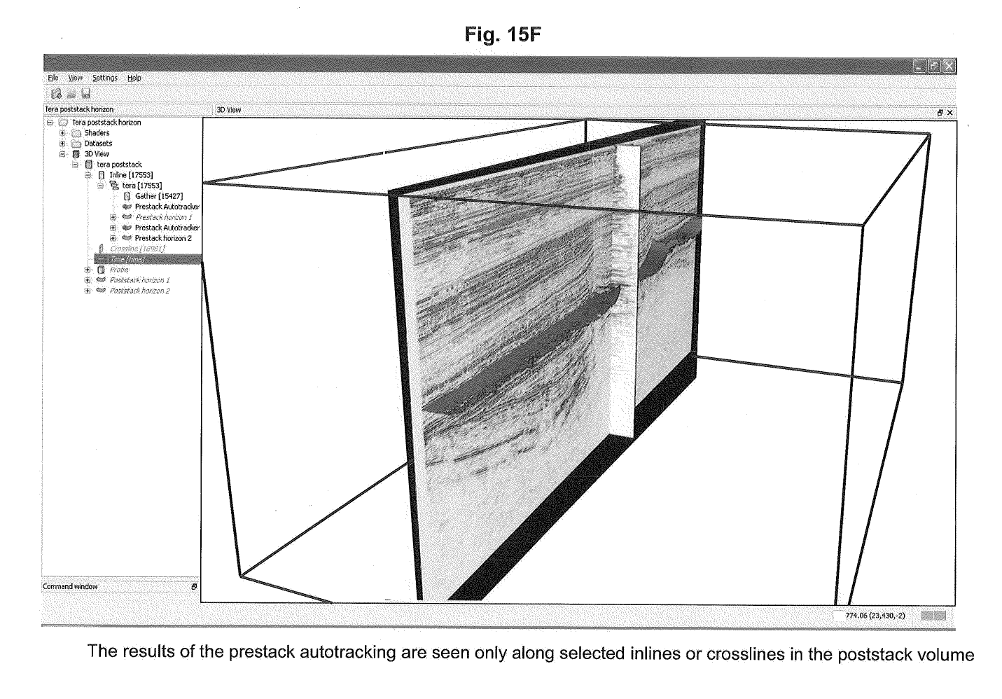

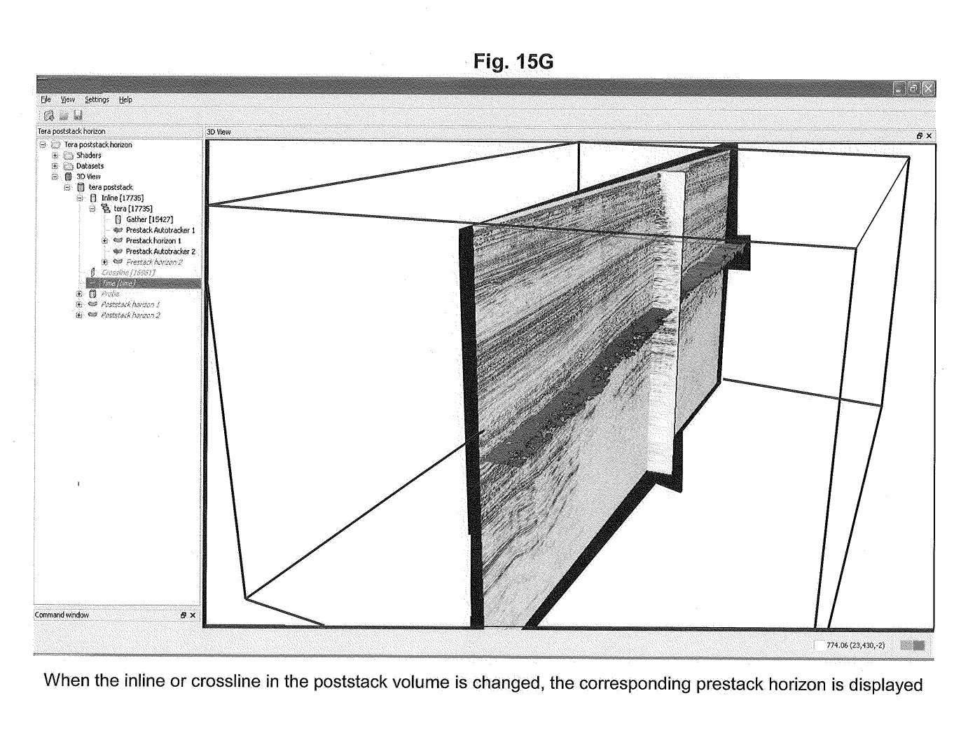

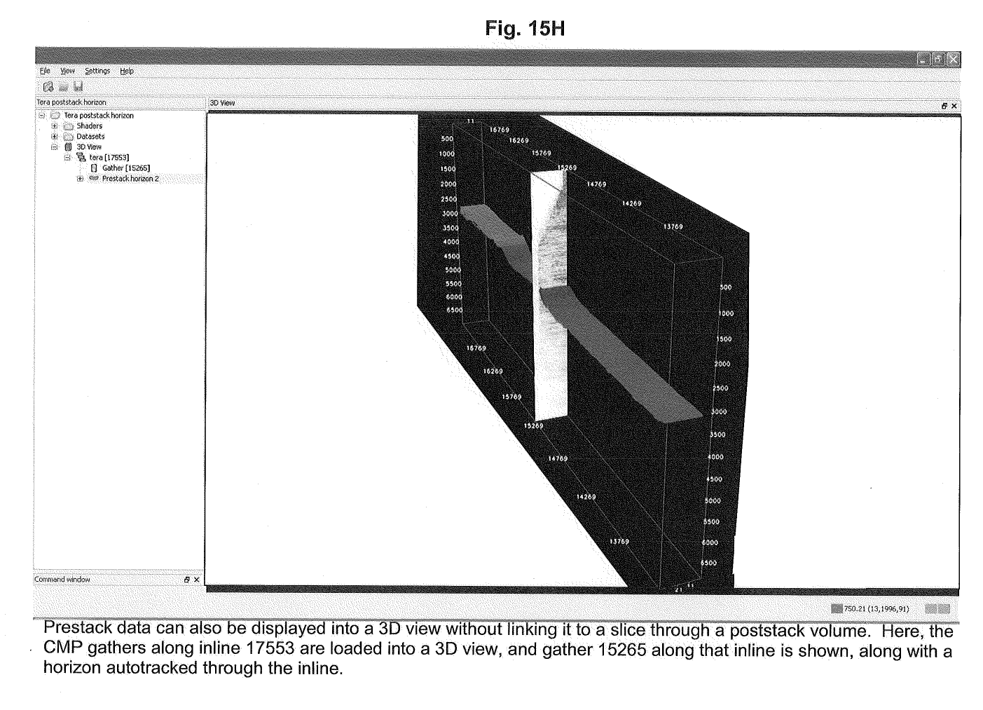

Once the prestack horizon information is stored as attributes in a Hyper Horizon file, in step 1106, the user is able to process and render the prestack horizon information using the GPU as previously discussed. There are many variations of visual representations of the prestack and poststack horizons, and prestack and poststack traces. For example, FIG. 13 illustrates seed points 1301 (indicated inside the circle) defined along the near offset prestack traces along an inline of gathers 1302. As shown in FIG. 14, the poststack horizon 1401 can be displayed along the near offset prestack traces 1402. FIGS. 15A through 15D illustrate the progression of auto-tracking of the prestack horizon along a single inline of gathers through the volume using the poststack time/depth values as the starting points as described above. This auto-tracking method however is not restricted to a single line of gathers through the volume. It may be performed on all gathers intersected by the poststack horizon simultaneously.

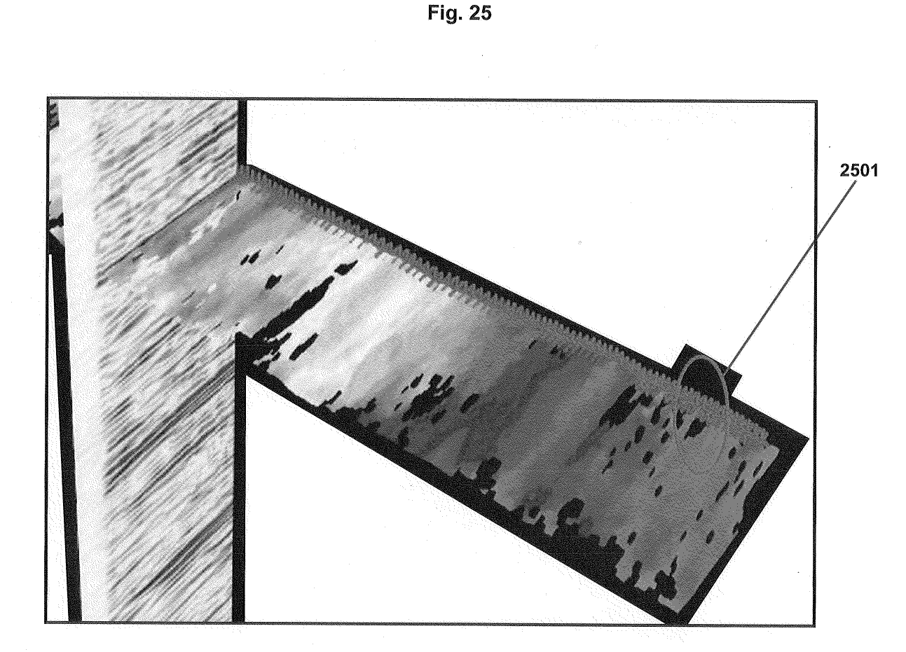

It should be noted that this method differs from other methods which may use a poststack horizon to provide seed points for prestack horizon auto-tracking, but which perform the tracking on a gather by gather basis. The method described above is distinct because the horizon tracked on any given gather may make use of a seed point provided by the poststack information to guide the auto-tracking, and may also make use of information from the event picked on adjacent gathers. Hence, in the case in which the seed points from a poststack horizon are placed on the near offset traces of the prestack data, the prestack horizon for a gather with low signal at the near offset trace can still be tracked by making use of the horizon tracked at further offsets in adjacent gathers. This is illustrated in FIG. 25. Referring to FIG. 25, in the circled area 2501, the signal of the prestack at some of the near offset traces was insufficient to track the prestack horizon at those gathers. However, the horizon was tracked at farther offsets along those gathers based on information from the prestack event picked on adjacent gathers.

While the above described interactive display or draping over surfaces of interest of any attributes is possible, for example, any prestack gather at any location in the postack volume, or even for all locations, viewing all the prestack data in a survey at once, however, may be in most cases too much information to interpret at once. Accordingly, the user may be allowed to select to see only those attributes and/or prestack data of interest. For example, prestack data can be selected for viewing by an association to a poststack inline or crossline, so that any prestack gather along the selected inline or crossline can be viewed. For example, in FIG. 15E, prestack gather adjacent a poststack trace of choice is displayed in perpendicular direction to the inline or crossline for that location.

Similarly, the results of the prestack autotracking based on the poststack horizon described above may also be selected, e.g., at any poststack inline or crossline. In this way, the results of the prestack autotracking are only displayed along the selected inline or crossline. An example of this can be seen in FIG. 15F. In addition, when a different inline or crossline is selected, the prestack horizon along the new inline or crossline position may be displayed as can be seen in FIG. 15G.

It is also possible to display a volume of prestack gathers, (say an inline or crossline of CMP gathers) in a 3D view without linking them to a slice through a poststack volume. As shown in FIG. 15H, an inline of CMP gathers is shown in a 3D view, with a slice through the offset plane, and the prestack horizon which was autotracked. The user may be given the ability to view the gathers and horizons along any other inline location. When another location is selected, the corresponding seismic and horizon data is loaded into the view.

Mapping of Attributes Extracted from Prestack Data onto Poststack Horizon

Another novel Analytical tool for interpretation of seismic data is proposed, in which the depth/time of a poststack horizon is used as the reference time around which to perform analysis of prestack gathers.

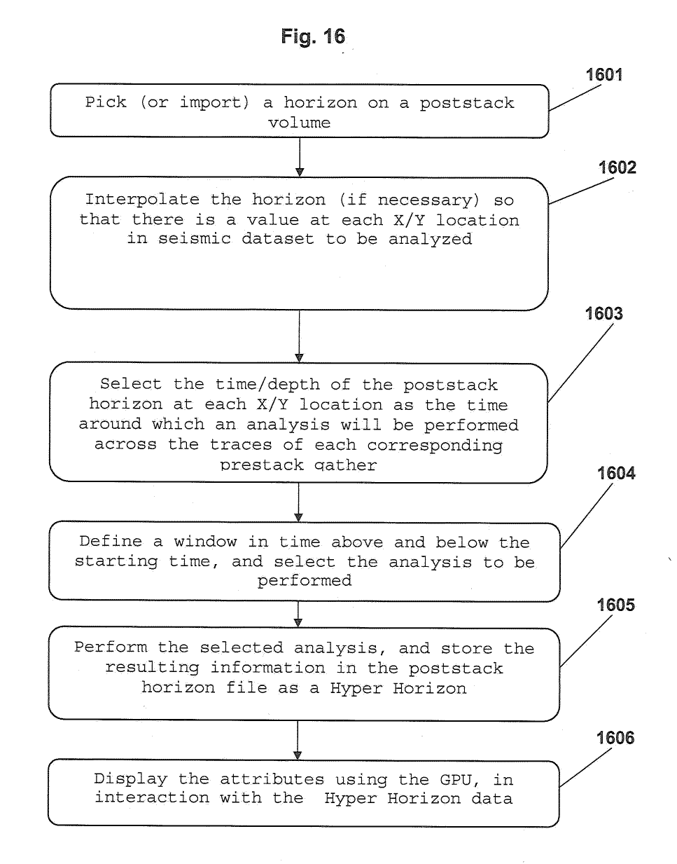

In particular, referring to FIG. 16, in step 1601, a horizon is chosen from the poststack seismic volume as previously described in connection with FIG. 6. In step 1602, as also previously described, if the horizon is imported from another application, an interpolation may be performed to ensure that each seismic trace, (Inline/Crossline intersection) that is intersected by the horizon has a time/depth value for the horizon at that location.

As previously discussed, each poststack seismic trace was created by averaging a number of prestack seismic traces. These prestack gathers are usually sorted in terms of offset, which is the distance between the seismic source, (blast, imploding bubble, etc.) and the seismic receiver (geophone, hydrophone, etc.). The near offset trace is that with the least distance between source and receiver, and the far offset trace is that with the most distance.

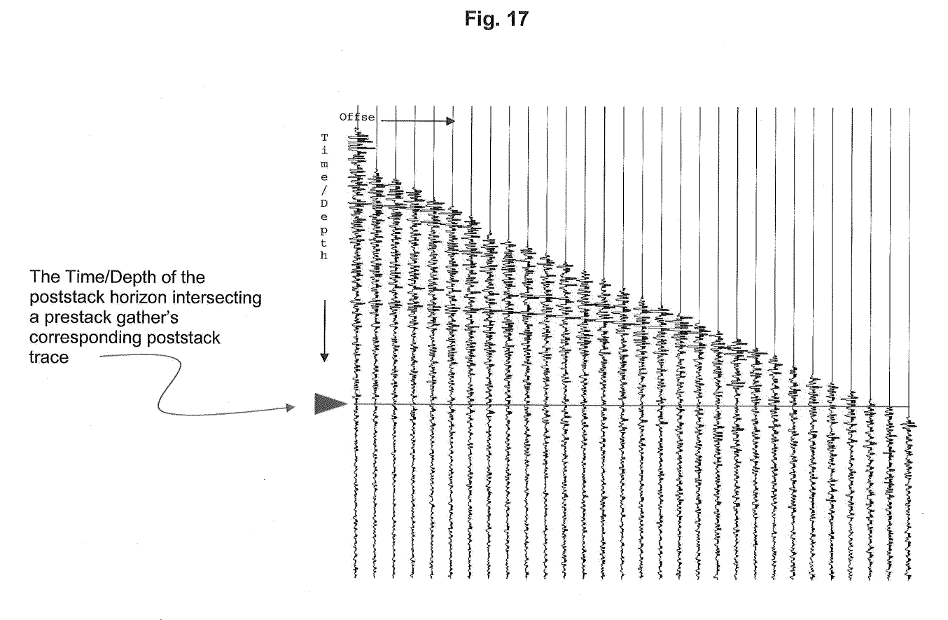

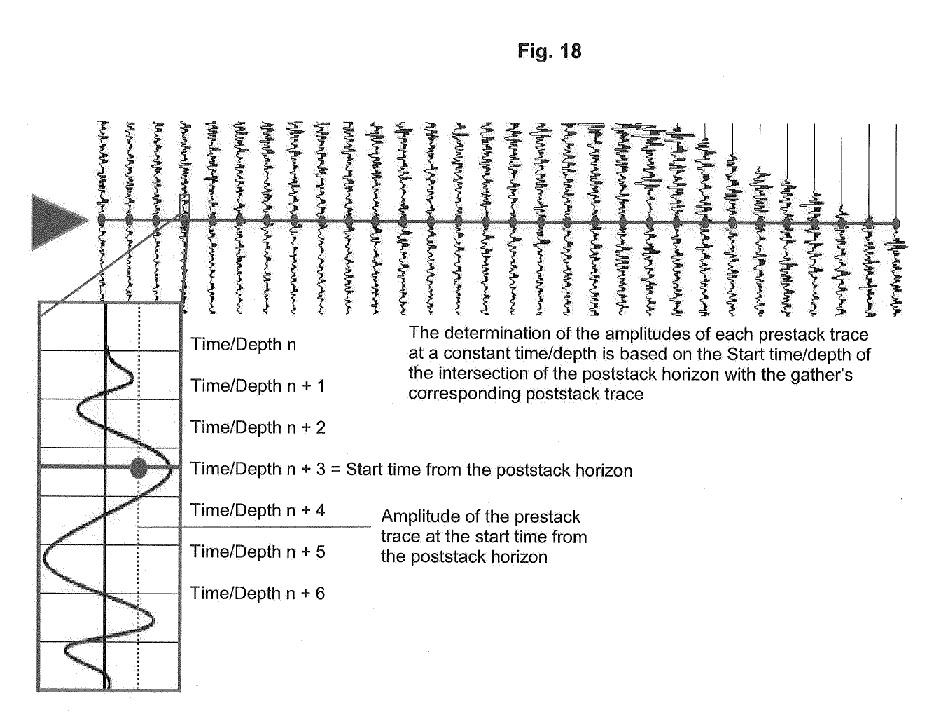

In step 1603, the time/depth values of the poststack horizon are selected as starting times for extraction of attributes across the seismic traces in the corresponding prestack gathers (See, e.g., FIG. 17). Then, in step 1604, the user may define a window in time above and below the starting time, as well as the type of analyses to be performed. In step 1605, the selected analysis is performed, and the attributes extracted during the analysis are stored as attributes in a Hyper Horizon file as previously described. Some examples of analysis might be to determine the average amplitude of each prestack trace over the defined window in time, or to determine the amplitude of a range of frequencies across all the prestack traces within the window of time. While there are a long list of possible attributes that can be extracted from the prestack data, as an illustration, the determination of the amplitude of each prestack trace at the “Start Time” (i.e., the time of intersection of the poststack horizon with the gather's corresponding poststack trace) is shown in FIG. 18. As can be seen the amplitudes of each prestack trace at a constant time/depth can be obtained by taking the time.depth of the intersection of the poststack horizon with the prestack traces.

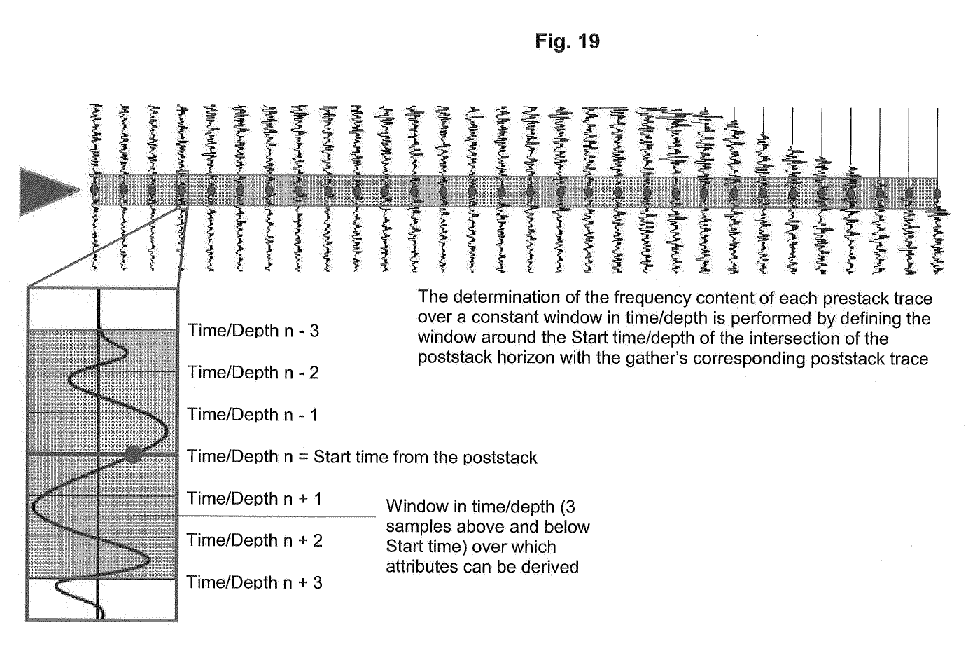

Another example of extracting attributes relating to the prestack gathers is to define a window in time/depth above and/or below the Start Time, and to extract attributes within the window at each prestack trace as illustrated in FIG. 19. An example of an attribute derived in this fashion might be the determination of the amplitude of the frequency content of the seismic data in bands of 0-10 Hz, 10-20 Hz, 20-30 Hz, . . . 110-120 Hz.

Once the desired attributes have been extracted from the seismic data, and stored in a Hyper Horizon file, the attributes are available for interactive display using the GPU in step 1606 as previously described, and as a color-coded or grey level variation drape over a poststack horizon similarly to examples shown in FIGS. 9 through 10C.

Mapping of Attributes Extracted from Prestack Horizon Prestack Horizon onto Poststack Horizon

Yet another novel Analytical tool for interpretation of seismic data is proposed, in which the prestack horizon is used as the reference around which to perform analysis of prestack gathers.

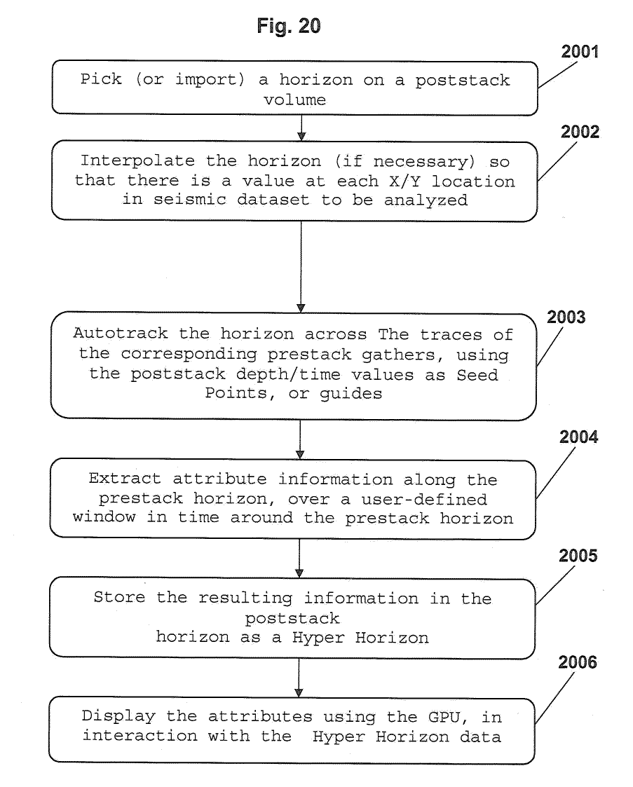

In particular, referring to FIG. 20, in step 2001, a horizon is chosen from the poststack seismic volume as previously described in connection with FIG. 6. In step 1602, as also previously described, if the horizon is imported from another application, an interpolation may be performed to ensure that each seismic trace, (Inline/Crossline intersection) that is intersected by the horizon has a time/depth value for the horizon at that location.

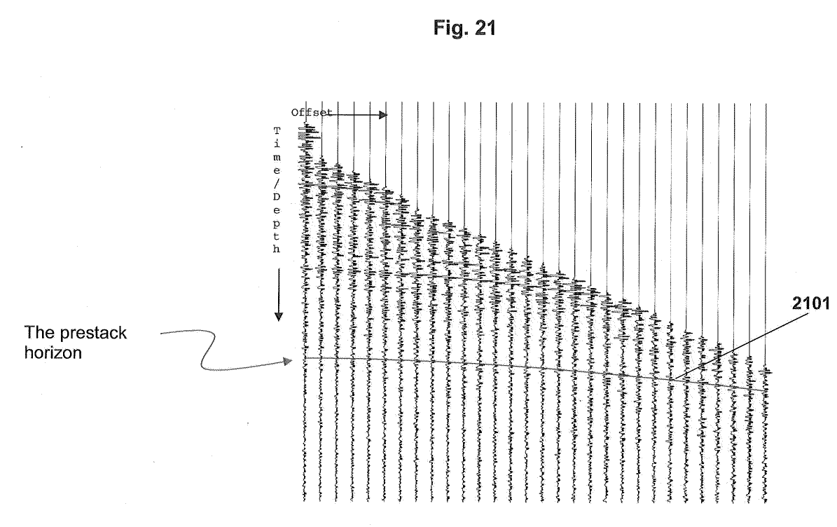

Then in step 2003, a horizon autotracking algorithm is performed on the prestack dataset, using the poststack horizon to define the target amplitude, wavelet or other characteristic, and using the poststack horizon depth time values as the seed points as previously described in connection with discussion of FIG. 11. An example of so tracked prestack horizon 2101 is shown in FIG. 21.

The newly tracked prestack horizon is then used for the extraction of attributes across the traces in the prestack gathers in step 2004. Either the analysis is performed at the point that the horizon intersects each trace, or user defines a window in time/depth above and below the horizon. The user must specify the type of analyses to be performed. Some examples of analysis might be to determine the amplitude of each prestack trace at the intersection of the horizon, or to determine for each trace the amplitude of a range of frequencies within a user specified window of time as previously discussed.

Once the desired attributes have been extracted from the seismic data, and stored in a Hyper Horizon file in step 2005, the attributes are available for interactive display using the GPU in step 2006 as previously described, and as a color-coded or grey level variation drape over a poststack horizon similarly to examples shown in FIGS. 9 through 10C.

By extracting attributes along a horizon in the prestack gathers, e.g., the effect of poorly chosen velocity corrections (for the purpose of NMO correction as previously discussed) may be negated.

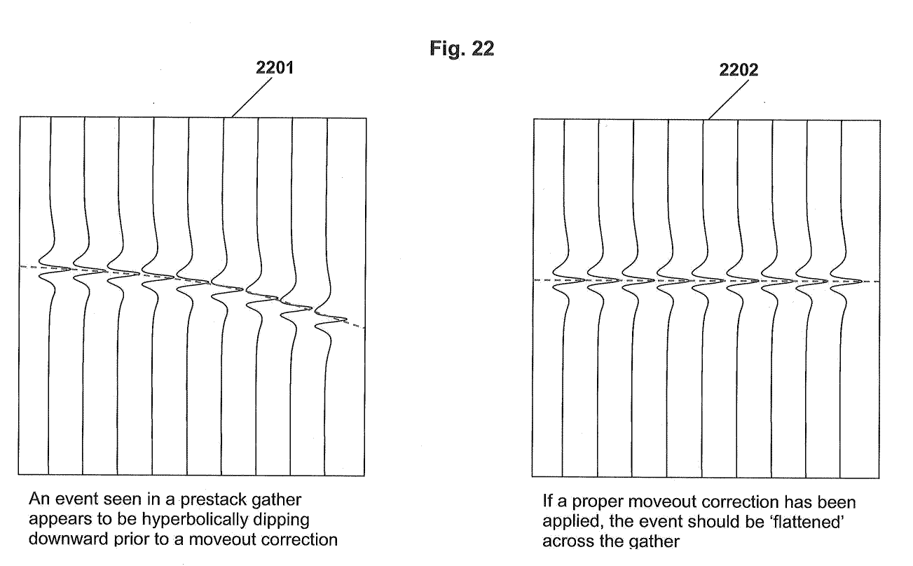

The arrival time/depths of geological events as seen in the prestack traces naturally increase with offset in the gathers. Events seen in prestack gathers 2201 appear to be hyperbolically dipping downward as shown in FIG. 22. As previously discussed, before stacking the prestack gathers to form a poststack seismic trace, a velocity correction must be applied, so that events in the prestack gathers 2202 are aligned horizontally as shown in FIG. 22.

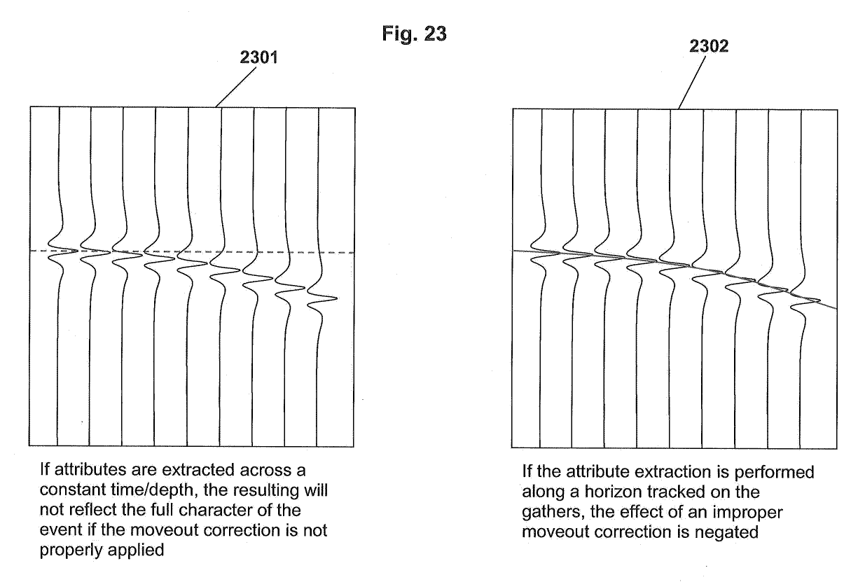

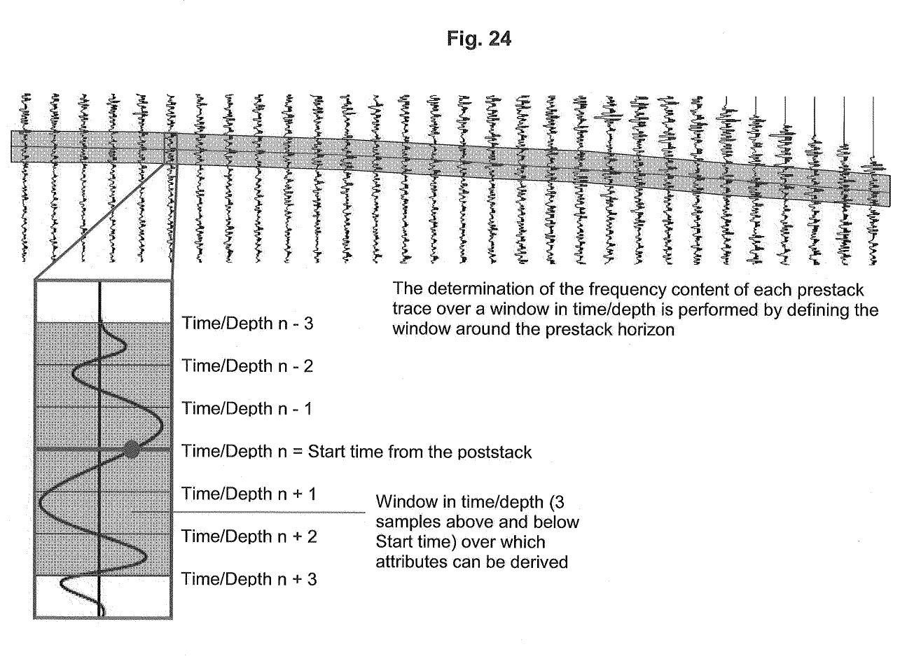

If the extraction of attributes is performed across the prestack traces at a single time/depth, or at a constant window in time/depth, and the moveout correction has not been applied correctly, the resulting attributes may not reflect the full character of the event as indicated by the prestack gathers 2301 in FIG. 23. By tracking the event across the gather, and extracting the attributes along the horizon rather than a constant time/depth as illustrated in FIG. 24, the effect of an improperly applied moveout correction may become apparent as shown by the prestack gathers 2302 in FIG. 23.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

1. A method of processing seismic data, comprising:
storing in a single file structure a first type of data representing an inline location, a second type of data representing a crossline location, and a third type of data representing at least one of a depth and time, said first, second and third type of data each being associated with a horizon of a poststack seismic trace at a location defined by said inline location and said crossline location; and
storing in said single file structure at least a fourth type of data representing an attribute associated with said horizon of said poststack seismic trace at said location.

2. The method of processing seismic data as set forth in claim 1, further comprising:
retrieving said first, second and third type of data; and
extracting said fourth type data based on said retrieved first, second and third type of data.

3. The method of processing seismic data as set forth in claim 2, wherein said step of extracting said fourth data type comprises:
obtaining amplitude values for samples within a predetermined range along said poststack seismic trace.

4. The method of processing seismic data as set forth in claim 1, further comprising:
displaying said fourth type of data as a variation of at least one of color and grey scale over said horizon.

5. The method of processing seismic data as set forth in claim 4, wherein said method of displaying is performed using a graphics processing unit:

6. A method of processing seismic data, comprising:
selecting a poststack horizon from a poststack volume;
selecting at least one of time and depth value of said poststack horizon at an intersection of said poststack horizon with at least one prestack gather as a seed point; and
performing a horizon tracking on said at least one prestack gather starting with said seed points to obtain a prestack horizon.

7. The method of processing seismic data as set forth in claim 6, further comprising:
storing in a single file structure an inline location of said intersection, a crossline location of said intersection, at least one of a depth and time of said poststack horizon at said intersection, and at least one of time and depth of said prestack horizon.

8. The method of processing seismic data as set forth in claim 7, further comprising:
displaying said at least one of time and depth of said prestack horizon as a variation of at least one of color and grey scale over said poststack horizon.

9. The method of processing seismic data as set forth in claim 8, wherein said method of displaying is performed using a graphics processing unit:

10. A method of processing seismic data, comprising:
selecting a poststack horizon from a poststack volume;
selecting at least one of time and depth value of said poststack horizon at an intersection of said poststack horizon with at least one prestack gather as a reference point; and
performing an analysis of prestack gather data at least one of at said reference point and within a predetermined window about said reference point to obtain an attribute.

11. The method of processing seismic data as set forth in claim 10, further comprising:
storing in a single file structure an inline location of said intersection, a crossline location of said intersection, at least one of a depth and time of said poststack horizon at said intersection, and said attribute.

12. The method of processing seismic data as set forth in claim 11, further comprising:
displaying said attribute as a variation of at least one of color and grey scale over said poststack horizon.

13. The method of processing seismic data as set forth in claim 12, wherein said method of displaying is performed using a graphics processing unit:

14. A method of processing seismic data, comprising:
selecting a poststack horizon from a poststack volume;
selecting at least one of time and depth value of said poststack horizon at an intersection of said poststack horizon with at least one prestack gather as a seed point;
performing a horizon tracking on said at least one prestack gather starting with said seed points to obtain a prestack horizon; and
selecting at least one of time and depth value of said prestack horizon as a reference point; and
performing an analysis of prestack gather data at least one of at said reference point and within a predetermined window about said reference point to obtain an attribute.

15. The method of processing seismic data as set forth in claim 14, further comprising:
storing in a single file structure an inline location of said intersection, a crossline location of said intersection, at least one of a depth and time of said poststack horizon at said intersection, and said attribute.

16. The method of processing seismic data as set forth in claim 15, further comprising:
displaying said attribute as a variation of at least one of color and grey scale over said poststack horizon.

17. The method of processing seismic data as set forth in claim 16, wherein said method of displaying is performed using a graphics processing unit:

18. The method of processing seismic data as set forth in claim 16, further comprising:
determining, based on said displayed attribute, an effectiveness of a velocity correction made during stacking of said prestack gathers.
